(19) United States
(12) Patent Application Publication
(10) Pub. No.: US 2006/0080067 A1
(43) Pub. Date: Apr. 13, 2006

(54) Methods and systems for compact modeling of large linear circuits with a large number of terminals

(75) Inventors: Peter Feldmann, New York, NY (US); Ying Liu, Austin, TX (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/961,356

(22) Filed: Oct. 7, 2004

(51) Int. Cl. G06F 17/10

(52) U.S. Cl. 703/2

(57) ABSTRACT

The methods and apparatus of the present invention perform model order reduction on models of complex electric circuits. In particular, the methods and apparatus of the present invention perform model order reduction on models of complex electric circuits by recursively selecting sub-blocks of an overall model of the complex electric circuit where there are likely to be correlations between the input terminals or between the output terminals of the sub-blocks; generating new models of the sub-blocks by removing aspects associated with correlated input terminals or correlated output terminals; and inserting the new models of the sub-blocks in the overall model of the complex electric circuit.

### FIELD OF THE INVENTION

The present invention generally concerns methods and apparatus for reducing the complexity of models used to simulate and design electric and electronic circuitry, and more particularly concerns an iterative method for substituting reduced order models for sub-blocks of an overall circuit model until redundancy in the model associated with correlated input and output terminals has been reduced or substantially eliminated. The methods and apparatus of the present invention are similarly applicable for use in model order reduction of models of linear systems.

### BACKGROUND OF THE INVENTION

Model order reduction (MOR) has become an established technique for the analysis and compact modeling of linear circuits and systems. In the past decade numerous algorithms have been devised for the computation of reduced-order models. Model order reduction is useful when only signal behavior at the inputs and outputs of the linear block is of interest. MOR techniques generate compact models of the circuit that approximate well circuit behavior at the input and output terminals but sacrifice the modeling of behavior at internal nodes.

Unfortunately the efficiency of model order reduction degrades as the number of external terminals to the circuit increases. The reason for this degradation is fundamental and does not depend on the particular reduction algorithm. A multi-terminal circuit is described by an m×m matrix-valued transfer function, where m is the number of external terminals. Each entry in the transfer function matrix characterizes the interaction between a pair of two terminals, O(m²) of such interactions. Moreover, in general, there is no basis to the assumption that any of the interactions is magnitude-wise insignificant, therefore the matrix-valued transfer function must be assumed to be fully populated. Any reduced-order model must approximate in some sense this matrix-valued transfer function. Therefore unless some special properties of the circuit are exploited, the complexity of the reduced order model is at least O(m²), which for a circuit with numerous inputs and outputs may approach or even surpass the complexity of working with the original, unreduced circuit equations.

A method (hereinafter referred to as the “compression method”) disclosed in related U.S. application Ser. No. ______, filed on the same date as this application and hereby incorporated by reference in its entirety as if fully restated herein, takes advantage of situations when the matrix transfer function is numerically close to being low rank and generates for it a compact and sparse reduced order model. While the compression method disclosed in U.S. application Ser. No. ______ achieves excellent sparsification on these types of transfer functions, a complete matrix transfer function of a subcircuit (relating all port currents and voltages), is very rarely low rank. On the other hand it may contain important low-rank sub-blocks. Consider, for example, the power grid section illustrated in FIG. 1. Here the inputs and outputs are the edges of the wire on the right and on the left of the section. The complete matrix transfer function that relates the currents and the voltages at all the ports of the section as required to represent its behavior in a higher level simulation, is very large and is also full rank. Therefore the compression method disclosed in U.S. application Ser. No. ______ can achieve no practical compression on the entire matrix. On the other hand, the submatrix-transfer function that relates the voltages on the left side to the currents on the right is very accurately approximated by a low rank transfer function and the compression algorithm achieves a significant sparsification of this off-diagonal sub-block.

Thus, those skilled in the art desire methods and apparatus for reducing model order complexity of electric circuit models. In particular, those skilled in the art desire methods and apparatus that apply methods of model reduction on sub-blocks of complex electric circuit models where there are correlations between input terminals or between output terminals. Those skilled in the art also desire iterative methods that successively reduce the model order complexity of sub-blocks of a model of a complex electric circuit until instances of correlations between input terminals or between output terminals have been eliminated. Those skilled in the art further desire new methods and apparatus for model order reduction that can be used in combination with conventional model order techniques in order to further improve the performance of conventional model order reduction techniques.

Many of the same problems are likewise encountered in the modeling of linear systems (both discrete and analogue). Accordingly, model order reduction methods and apparatus applicable to models of linear systems are also sought.

### SUMMARY OF THE PREFERRED EMBODIMENTS

The foregoing and other problems are overcome, and other advantages are realized, in accordance with the presently preferred embodiments of these teachings. The present invention comprises systems and methods for simplifying the modeling of complex circuits. In particular, a first alternate embodiment of the present invention comprises a signal-bearing medium tangibly embodying a program of machine-readable instructions executable by a digital processing apparatus of a computer system to perform operations comprising model order reduction of a complex electric circuit, the operations comprising: formulating a set of expressions that describe the input and output characteristics of the complex electric circuit, wherein the set of expressions comprises a first model of the complex electric circuit; selecting a first sub-block of the first model of the complex electric circuit where the first sub-block corresponds to a first subset of input terminals to and output terminals from the complex electric circuit, wherein at least one correlation in response behavior is likely to exist between at least two input terminals comprising the first subset of input and output terminals; formulating a set of expressions that relate the input terminals and output terminals comprising the first subset, wherein the set of expressions comprises a first model of the first sub-block; performing mathematical operations on the first model of the first sub-block to identify at least one correlation between at least two input terminals of the first subset of input terminals to and output terminals from the complex electric circuit; generating a reduced-order second model of the first sub-block by removing from the first model aspects associated with correlated input terminals; and inserting the reduced-order second model of the first sub-block in the first model of the complex electric circuit at a position reserved for the first sub-block.

As used herein, “electric circuit” generically refers to electric and electronic circuits. In addition, as used herein “complex electric circuit” refers to a particularly complicated electric or electronic circuit, and not to imaginary mathematical aspects (e.g., aspects represented by complex numbers) of such an electrical circuit, although “a model of a complex electric circuit” as used herein may certainly comprise, in part, imaginary mathematical aspects (e.g., aspects represented by complex numbers).

In one variant of the first alternate embodiment of the present invention, the operations further comprise: recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals comprising each of the additional subsets; formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks; performing mathematical operations on the first models of the additional sub-blocks to identify at least one correlation between at least two input terminals for each of the additional sub-blocks; generating reduced-order second models for each of the additional sub-blocks by removing from the first models aspects associated with correlated input terminals; and successively inserting the reduced-order second models of the additional sub-blocks in the model of the complex electric circuit at respective positions reserved for each of additional sub-blocks, wherein each successive insertion creates a new overall model of the complex electric circuit.

A second alternate embodiment of the present invention comprises a program of machine-readable instructions executable by a digital processing apparatus of a computer system to perform operations comprising model order reduction of a complex electric circuit, the operations comprising: formulating a set of expressions that describe the input and output characteristics of the complex electric circuit, wherein the set of expressions comprises a first model of the complex electric circuit; selecting a first sub-block of the first model of the complex electric circuit where the first sub-block corresponds to a first subset of input terminals to and output terminals from the complex electric circuit, wherein at least one correlation in response behavior is likely to exist between at least two output terminals comprising the first subset of input and output terminals; formulating a set of expressions that relate the input terminals and output terminals comprising the first subset, wherein the set of expressions comprises a first model of the first sub-block; performing mathematical operations on the first model of the first sub-block to identify at least one correlation between at least two output terminals of the first subset of input terminals to and output terminals from the complex electric circuit; generating a reduced-order second model of the first sub-block by removing from the first model aspects associated with correlated output terminals; and inserting the reduced-order second model of the first sub-block in the first model of the complex electric circuit at a position reserved for the first sub-block.

In one variant of the second alternate embodiment of the present invention, the operations further comprise: recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two output terminals comprising each of the additional subsets; formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks; performing mathematical operations on the first models of the additional sub-blocks to identify at least one correlation between at least two output terminals for each of the additional sub-blocks; generating reduced-order second models for each of the additional sub-blocks by removing from the first models aspects associated with correlated output terminals; and successively inserting the reduced-order second models of the additional sub-blocks in the model of the complex electric circuit at respective positions reserved for each of the additional sub-blocks, wherein each successive insertion creates a new overall model of the complex electric circuit.

A third alternate embodiment of the present invention comprises: a signal-bearing medium tangibly embodying a program of machine-readable instructions executable by a digital processing apparatus of a computer system to perform operations comprising model order reduction of a complex electric circuit, the operations comprising: formulating a set of expressions that describe the input and output characteristics of the complex electric circuit, wherein the set of expressions comprises a first model of the complex electric circuit; selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals; formulating a set of expressions that relate the input terminals and output terminals comprising the first subset, wherein the set of expressions comprises a first model of the first sub-block; performing mathematical operations on the first model of the first sub-block to identify at least one correlation between at least two input terminals or between at least two output terminals of the first subset of input terminals to and output terminals from the complex electric circuit; generating a reduced-order second model of the first sub-block by removing from the first model aspects associated with correlated input terminals or correlated output terminals; and inserting the reduced-order second model of the first sub-block in the first model of the complex electric circuit at a position reserved for the first sub-block.

In one variant of the third alternate embodiment of the present invention, performing mathematical operations on the first model of the first sub-block further comprises: performing singular value decomposition on the first model of the first sub-block.

In another variant of the third alternate embodiment of the present invention, generating a reduced-order second model of the first sub-block further comprises: selecting a suitable tolerance for modeling the first sub-block; eliminating from the singular value decomposition of the first model of the first sub-block singular values not needed to achieve the desired modeling tolerance; and creating a second reduced-order model of the first sub-block from the retained singular values.

In a further variant of the third alternate embodiment of the present invention, the operations further comprise: selecting a second sub-block from a second model of the complex electric circuit created when the second reduced-order model of the first sub-block is substituted in the first model of the complex electric circuit, wherein the second sub-block corresponds to a second subset of input terminals to and output terminals from the complex electric circuit, wherein at least one correlation in response behavior is likely to exist between at least two input terminals or between at least two output terminals comprising the second subset of input and output terminals; formulating a set of expressions that relate the input terminals and output terminals comprising the second subset, wherein the set of expressions comprises a first model of the second sub-block; performing mathematical operations on the first model of the second sub-block to identify at least one correlation between at least two input terminals or between at least two output terminals of the second subset of input terminals to and output terminals from the complex electric circuit; generating a reduced-order second model of the second sub-block by removing from the first model aspects associated with correlated input terminals or correlated output terminals; and inserting the reduced-order second model of the second sub-block in the second model of the complex electric circuit at a position reserved for the second sub-block.

In yet another variant of the third alternate embodiment of the present invention, the operations further comprise: recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets; formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks; performing mathematical operations on the first models of the additional sub-blocks to identify at least one correlation between at least two input terminals or between at least two output terminals of the additional sub-blocks; generating reduced-order second models for each of the additional sub-blocks by removing from the first models aspects associated with correlated input terminals or correlated output terminals; and successively inserting the reduced-order second models of the additional sub-blocks in the model of the complex electric circuit at respective positions reserved for each of the additional sub-blocks, wherein each successive insertion creates a new overall model of the complex electric circuit.

In a still further variant of the third alternate embodiment of the present invention, performing mathematical operations on the first models of the additional sub-blocks further comprises: performing linear algebraic manipulations on the first models of the additional sub-blocks to identify at least one correlation between at least two input terminals or between at least two output terminals for each of the additional sub-blocks.

In another variant of the third alternate embodiment of the present invention, performing linear algebraic manipulations further comprises: performing singular value decomposition on each of the first models of the additional sub-blocks.

In a further variant of the third alternate embodiment of the present invention, generating reduced-order second models of the additional sub-blocks further comprises: eliminating from the singular value decompositions of the first models of the additional sub-blocks null singular values associated with correlated input terminals or correlated output terminals; and creating reduced-order second models of the additional sub-blocks from the non-zero singular values of the singular value decomposition of the first models of the additional sub-blocks.

In yet another variant of the third alternate embodiment of the present invention, generating reduced-order second models of the additional sub-blocks further comprises: selecting a suitable tolerance for modeling the additional sub-blocks; eliminating from the singular value decompositions of the first models of the additional sub-blocks singular values not needed to achieve the desired modeling tolerance; and creating reduced-order second models of the additional sub-blocks from the retained singular values.

A fourth alternate embodiment of the present invention comprises: a signal-bearing medium tangibly embodying a program of machine-readable instructions executable by a digital processing apparatus of a computer system to perform operations comprising model order reduction of a complex electric circuit, the operations comprising: selecting which response characteristic of the complex electric circuit to model; formulating a set of expressions of sufficient accuracy to simulate the selected response characteristic at the input and output terminals of the complex electric circuit, wherein the set of expressions comprises a first model of the complex electric circuit; selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals; formulating a set of expressions that relate the input terminals and output terminals comprising the first subset, wherein the set of expressions comprises a first model of the first sub-block; performing mathematical operations on the first model of the sub-block to identify at least one correlation between at least two input terminals or between at least two output terminals of the first subset of input terminals to and output terminals from the complex electric circuit; generating a reduced-order second model of the first sub-block by removing from the first model aspects associated with correlated input terminals or correlated output terminals; and inserting the reduced-order second model of the first sub-block in the first model of the complex electric circuit at a position reserved for the first sub-block.

In one variant of the fourth alternate embodiment the operations further comprise: recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets; formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks; performing mathematical operations on the first models of the additional sub-blocks to identify at least one correlation between at least two input terminals or between at least two output terminals of the additional sub-blocks; generating reduced-order second models for each of the additional sub-blocks by removing from the first models aspects associated with correlated input terminals or correlated output terminals; and successively inserting the reduced-order second models of the additional sub-blocks in the model of the complex electric circuit at respective positions reserved for each of the additional sub-blocks, wherein each successive insertion creates a new overall model of the complex electric circuit.

In another variant of the fourth alternate embodiment of the present invention, performing mathematical operations on the first models of the additional sub-blocks further comprises: performing singular value decomposition on each of the first models of the additional sub-blocks.

In a further alternate embodiment of the fourth alternate embodiment of the present invention, generating reduced-order second models of the additional sub-blocks further comprises: selecting a suitable tolerance for modeling the additional sub-blocks; eliminating from the singular value decompositions of the first models of the additional sub-blocks singular values not needed to achieve the desired modeling tolerance; and creating reduced-order second models of the additional sub-blocks from the retained singular values.

A fifth alternate embodiment of the present invention comprises: a computer system for performing model order reduction on a model of a complex electric circuit, the computer system comprising: at least one memory to store at least (1) a description of the complex electric circuit and (2) at least one program of machine-readable instructions comprising operations which perform model order reduction on models of complex electric circuits when the at least one program is executed; at least one processor coupled to the at least one memory, wherein the at least one processor performs at least the following operations when the at least one program is executed: formulating a set of expressions from the description of the complex electric circuit that describe the input and output characteristics of the complex electric circuit, wherein the set of expressions comprises a first model of the complex electric circuit; selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals; formulating a set of expressions that relate the input terminals and output terminals comprising the first subset, wherein the set of expressions comprises a first model of the first sub-block; performing mathematical operations on the first model of the sub-block to identify at least one correlation between at least two input terminals or between at least two output terminals of the first subset of input terminals to and output terminals from the complex electric circuit; generating a reduced-order second model of the first sub-block by removing from the first model aspects associated with correlated input terminals or correlated output terminals; and inserting the reduced-order second model of the first sub-block in the first model of the complex electric at a position reserved for the first sub-block.

In one variant of the fifth alternate embodiment of the present invention, performing mathematical operations on the first model of the first sub-block further comprises: performing linear algebraic manipulations on the first model of the first sub-block to reveal at least one correlation between at least two input terminals or between at least two output terminals.

In another variant of the fifth alternate embodiment of the present invention, performing linear algebraic manipulations further comprises: performing singular value decomposition on the first model of the first sub-block.

In a further variant of the fifth alternate embodiment of the present invention, generating a reduced-order second model of the first sub-block further comprises: eliminating from the singular value decomposition of the first model of the first sub-block null singular values associated with correlated input terminals or correlated output terminals; and creating a second reduced-order model of the first sub-block from the non-zero singular values of the singular value decomposition of the first model.

In yet another variant of the fifth alternate embodiment of the present invention, generating a reduced-order second model of the first sub-blocks further comprises: recalling a user-specified tolerance for modeling the complex electric circuit; eliminating from the singular value decomposition of the first model of the first sub-block singular values not needed to achieve the desired modeling tolerance; and creating a second reduced-order model of the first sub-block from the retained singular values.

In a still further variant of the fifth alternate embodiment of the present invention, the operations further comprise: recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets; formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks; performing mathematical operations on the first models of the additional sub-blocks to identify at least one correlation between at least two input terminals or between at least two output terminals of the additional sub-blocks; generating reduced-order second models for each of the additional sub-blocks by removing from the first models aspects associated with correlated input terminals or correlated output terminals; and successively inserting the reduced-order second models of the additional sub-blocks in the model of the complex electric circuit at respective positions reserved for each of the additional sub-blocks, wherein each successive insertion creates a new overall model of the complex electric circuit.

In another variant of the fifth alternate embodiment of the present invention, performing mathematical operations on the first models of the additional sub-blocks further comprises: performing linear algebraic manipulations on the first models of the additional sub-blocks to identify at least one correlation between at least two input terminals or between at least two output terminals for each of the additional sub-blocks.

In a further variant of the fifth alternate embodiment of the present invention, performing linear algebraic manipulations further comprises: performing singular value decomposition on each of the first models of the additional sub-blocks.

In yet another variant of the fifth alternate embodiment of the present invention, generating reduced-order second models of the additional sub-blocks further comprises: eliminating from the singular value decompositions of the first models of the additional sub-blocks null singular values associated with correlated input terminals or correlated output terminals; and creating reduced-order second models of the additional sub-blocks from the non-zero singular values of the singular value decomposition of the first models of the additional sub-blocks.

In a still further variant of the fifth alternate embodiment of the present invention, generating reduced-order second models of the additional sub-blocks further comprises: selecting a suitable tolerance for modeling the additional sub-blocks; eliminating from the singular value decompositions of the first models of the additional sub-blocks singular values not needed to achieve the desired modeling tolerance; and creating reduced-order second models of the additional sub-blocks from the retained singular values.

In another variant of the fifth alternate embodiment of the present invention, the at least one memory comprises at least one remote database accessible over the internet, wherein the description of the complex electric circuit is stored in the at least one remote database.

In a further variant of the fifth alternate embodiment of the present invention, the at least one memory comprises at least one remote database accessible over the internet, wherein the at least one program for performing model order reduction is stored in the at least one remote database.

A sixth alternate embodiment of the present invention comprises: a computer system for performing model order reduction on a model of a complex electric circuit, the computer system comprising: at least one memory to store at least (1) a description of the complex electric circuit and (2) at least one program of machine-readable instructions comprising operations which perform model order reduction on models of complex electric circuits when the at least one program is executed; at least one processor coupled to the at least one memory, wherein the at least one processor performs at least the following operations when the at least one program is executed: recalling a user-specified selection corresponding to a desired response characteristic of the complex electric circuit; wherein that desired response characteristic of the complex electric circuit will be modeled by the computer system; formulating a set of expressions of sufficient accuracy to simulate the selected response characteristic at the input and output terminals of the complex electric circuit, wherein the set of expressions comprises a first model of the electric circuit; selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals; formulating a set of expressions that relate the input terminals and output terminals comprising the first subset, wherein the set of expressions comprises a first model of the first sub-block; performing mathematical operations on the first model of the sub-block to identify at least one correlation between at least two output terminals or between at least two output terminals of the first subset of input terminals to and output terminals from the complex electric circuit; generating a reduced-order second model of the first sub-block by removing from the first model aspects associated with correlated input terminals or correlated output terminals; and inserting the reduced-order second model of the first sub-block in the first model of the complex electric circuit at a position reserved for the first sub-block.

In one variant of the sixth alternate embodiment of the present invention, the operations further comprise: recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets; formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks; performing mathematical operations on the first models of the additional sub-blocks to identify at least one correlation between at least two input terminals or between at least two output terminals of the additional sub-blocks; generating reduced-order second models for each of the additional sub-blocks by removing from the first models aspects associated with correlated input terminals or correlated output terminals; and successively inserting the reduced-order second models of the additional sub-blocks in the model of the complex electric circuit at respective positions reserved for each of the additional sub-blocks, wherein each successive insertion creates a new overall model of the complex electric circuit.

In another variant of the sixth alternate embodiment of the present invention, performing mathematical operations on the first models of the additional sub-blocks further comprises: performing singular value decomposition on each of the first models of the additional sub-blocks.

In a further variant of the sixth alternate embodiment of the present invention, generating reduced-order second models of the additional sub-blocks further comprises: selecting a suitable tolerance for modeling the additional sub-blocks; eliminating from the singular value decompositions of the first models of the additional sub-blocks singular values not needed to achieve the desired modeling tolerance; and creating reduced-order second models of the additional sub-blocks from the retained singular values.

In yet another variant of the sixth alternate embodiment of the present invention, the desired response characteristic corresponds to the DC response of the complex electric circuit.

In a still further variant of the sixth alternate embodiment of the present invention, the desired response characteristic corresponds to the delay response of the complex electric circuit.

In another variant of the sixth alternate embodiment of the present invention, the desired response characteristic corresponds to the DC and the delay response of the complex electric circuit.

In a further variant of the sixth alternate embodiment of the present invention, the desired response characteristic corresponds to a frequency-shifted moment of the complex electric circuit.

A seventh alternate embodiment of the present invention comprises: a signal bearing medium tangibly embodying a program of machine-readable instructions executable by a digital processing apparatus of a computer system to perform operations comprising model order reduction of a linear system, the operations comprising: formulating a set of expressions that describe the input and output characteristics of the linear system, wherein the set of expressions comprises a first model of the linear system; selecting a first sub-block of the first model of the linear system where the first sub-block corresponds to a first subset of inputs to and outputs from the linear system, wherein at least one correlation in response behavior is likely to exist between at least two inputs or between at least two outputs comprising the first subset of inputs and outputs; formulating a set of expressions that describe the input and output characteristics of the first sub-block, wherein the set of expressions comprises a first model of the first sub-block; performing mathematical operations on the first model of the first sub-block to identify at least one correlation between at least two inputs or between at least two outputs of the first sub-block; generating a reduced-order second model of the first sub-block by removing from the first model of the first sub-block aspects associated with correlated inputs or correlated outputs; and inserting the reduced-order second model of the first sub-block in the first model of the complex linear system at a position reserved for the first sub-block.

In one variant of the seventh alternate embodiment of the present invention, the linear system further comprises an analogue system.

In another variant of the seventh alternate embodiment of the present invention, the linear system further comprises a discrete system.

An eighth alternate embodiment of the present invention comprises: a method for performing model order reduction on a model of a complex electric circuit, the method comprising: formulating a set of expressions that describe the input and output characteristics of the complex electric circuit, wherein the set of expressions comprises a first model of the electric circuit; recursively selecting sub-blocks of the model of the complex electric circuit, wherein each of the sub-blocks corresponds to a subset of input terminals to and output terminals from the complex electric circuit, wherein with respect to each of the subsets at least one correlation is likely to exist between at least two input terminals or between at least two output terminals comprising each of the subsets; formulating a set of expressions for each of the sub-blocks, wherein each set of expressions relates the input and output terminals of the subset corresponding to that sub-block, and where the sets of expressions for each of the sub-blocks comprise first models of each of the sub-blocks; performing mathematical operations on the first models of the sub-blocks to identify at least one correlation between at least two input terminals or between at least two output terminals of the sub-blocks; generating reduced-order second models for each of the sub-blocks by removing from the first models aspects associated with correlated input terminals or correlated output terminals; and successively inserting the reduced-order second models of the sub-blocks in the model of the complex electric circuit at respective positions reserved for each of the sub-blocks, wherein each successive insertion creates a new overall model of the complex electric circuit.

In one variant of the eighth alternate embodiment of the present invention, performing mathematical operations on the first models of the sub-blocks further comprises: performing singular value decomposition on each of the first models of the sub-blocks.

In another variant of the eighth alternate embodiment of the present invention, generating reduced-order second models of the sub-blocks further comprises: selecting a suitable tolerance for modeling the sub-blocks; eliminating from the singular value decompositions of the first models of the sub-blocks singular values not needed to achieve the desired modeling tolerance; and creating reduced-order second models of the sub-blocks from the retained singular values.

A ninth alternate embodiment of the present invention comprises: a method for performing model order reduction on a model of a complex electric circuit, the method comprising: selecting which response characteristic of the complex electric circuit to model; formulating a set of expressions of sufficient accuracy to simulate the selected response characteristics at the input and output terminals of the complex electric circuit, wherein the set of expressions comprises a first model of the complex electric circuit; recursively selecting sub-blocks of the model of the complex electric circuit, wherein each of the sub-blocks corresponds to a subset of input terminals to and output terminals from the complex electric circuit, wherein with respect to each of the subsets at least one correlation is likely to exist between at least two input terminals or between at least two output terminals comprising each of the subsets; formulating a set of expressions for each of the sub-blocks, wherein each set of expressions relates the input and output terminals of the subset corresponding to that sub-block, and where the sets of expressions for each of the sub-blocks comprise first models of each of the sub-blocks; performing mathematical operations on the first models of the sub-blocks to identify at least one correlation between at least two input terminals or between at least two output terminals of the sub-blocks; generating reduced-order second models for each of the sub-blocks by removing from the first models aspects associated with correlated input terminals or correlated output terminals; and successively inserting the reduced-order second models of the sub-blocks in the model of the complex electric circuit at respective positions reserved for each of the sub-blocks, wherein each successive insertion creates a new overall model of the complex electric circuit.

In one variant of the ninth alternate embodiment of the present invention, performing mathematical operations on the first models of the sub-blocks further comprises: performing singular value decomposition on each of the first models of the sub-blocks.

In another variant of the ninth alternate embodiment of the present invention, generating reduced-order second models of the sub-blocks further comprises: selecting a suitable tolerance for modeling the sub-blocks; eliminating from the singular value decompositions of the first models of the sub-blocks singular values not needed to achieve the desired modeling tolerance; and creating reduced-order second models of the sub-blocks from the retained singular values.

The foregoing alternate embodiments of the present invention are exemplary and non-limiting. For example, one of ordinary skill in the art will understand that one or more aspects or steps from one alternate embodiment can be combined with one or more aspects or steps from another alternate embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a power grid section the modeling and simulation of which is suitable for application of the methods and apparatus of the present invention;

FIG. 2 is a block diagram depicting a method in accordance with an alternate embodiment of the present invention;

FIG. 3 depicts a computer system suitable for practicing the methods of the present invention;

FIG. 4 is a graph depicting the accuracy of the methods of the present invention in comparison to those of the prior art;

FIG. 5 is a graph depicting the result of application of the iterative methods of the present invention resulting in a sparse, block-structured matrix;

FIG. 6 depicts a power grid section implemented in three layers of metal the modeling and simulation of which is suitable for application of the methods and apparatus of the present invention;

FIG. 7 depicts the first moment response of the power grid section depicted in FIG. 6;

FIG. 8 depicts the results of the application of the methods of the present invention on a model of the power grid section depicted in FIG. 6;

FIG. 9 is a graph depicting the relatively low error incurred in applying the methods of the present invention; and

FIG. 10 is a block diagram of an alternate method in accordance with the present invention.

### DETAILED DESCRIPTION OF THE PREFERRED EMBODIMENTS

Before proceeding with a description of the preferred embodiments of the present invention, the essence of MOR methods will be described. It is of interest to compute the reduced-order model for a linear complex electric circuit characterized by a large number of input and output terminals. The general state-space formulation of the circuit is

$$\begin{matrix}C \frac{ⅆ}{ⅆ t} x + Gx = Mu \\ y = {N}^{T} x\end{matrix} \qquad ( 1 )$$

Here C and G are n×n matrices describing the reactive and dissipative parts of the circuit, respectively. M is a n×p matrix that defines the input ports, and N is a n×q matrix that defines the outputs. For most circuits these matrices are quite sparse.

As used herein, “electric circuit” generically refers to electric and electronic circuits.

A large class of MOR methods operates on the Laplace-domain transfer function of the multi-port circuit. The Laplace transform of the input/output transfer function has the expression
H(s)=N^{T}(G+sC)⁻¹M, (2)
and is in fact a q×p matrix-valued rational function.

Padé-based MOR algorithms operate on the original circuit matrices G, C, M, N and compute models described by smaller matrices, which usually are just projections of the circuit matrices in well-chosen subspaces. The transfer function of the reduced-order models approaches the original in the Padé approximation sense
H(s)≈Hₗ(s)=Nₗ^{T}(Gₗ+sC₁)⁻¹Mₗ. (3)

In this reduced-order model (3) Gₗ and Cₗ are l×l matrices where l depends on the number of input/output ports and the order of approximation. Typically, l is much smaller than n, the size of the original system matrices and, therefore, the reduced-order model is expressed in terms of significantly smaller matrices.

However, reduced-order model matrices may be much denser. The number of non-zero entries in the reduced-order model matrices is increasing rapidly with the number of input/output ports and is the order of O(pq), while for typical circuits, the system matrices G and C are very sparse, having a number of non-zero entries of order Q(n). This situation causes the benefits of model-order reduction (compactness and computational efficiency) to vanish rapidly as the number of I/O ports is increased.

The model order reduction methods described in co-pending application Ser. No. ______ exploit the structure of a wide class of transfer functions and can often result in compact reduced-order models even for circuits with large numbers of I/O ports. Matrix N and M encode all the input/output port definitions. Obviously in many applications, the responses at the circuit inputs and outputs are not independent. On the contrary, typically there is a large degree of correlation between circuit responses at various ports. Such a correlation would manifest itself in the matrix H having highly dependent entries, or in other words with H being well approximated by a lower rank matrix. In an actual complex electric or electronic circuit, such correlations would manifest themselves when, e.g., two output terminals have similar or nearly identical responses to the same input excitation

Note that in the current formulation, M and N only contain topology information. The compression algorithm first transforms the equations in a way that reveals circuit response correlations. One possible transformation focuses on the DC response of the circuit H_{DC}. For a highly regular circuit it is expected that this matrix will be highly correlated and therefore to be well-approximated by a low rank system. The approximation is determined by performing SVD and keeping only the important singular values.
H_{DC}=M^{T}G⁻¹N=UΣW^{T} (4)
where Σ=diag(σ₁, . . . , σₘ), and U and W are orthogonal matrices. Note that the unusual notation W is chosen instead of the traditional V in order to avoid confusion with the voltage variables. In many important situations there will be a relatively small number of dominant singular values, say σ₁, . . . , σₘ, r [symbol] m, and the error caused by setting the remaining singular values to zero, will be relatively small. In these cases
B=UΣW^{T}≈UᵣΣᵣWᵣ^{T} (5)
Other good matrices for revealing correlations are the first moment of response M₁=M^{T}G⁻¹CG⁻¹N, frequency shifted moments Mₛ_{₀}=M^{T}(G+s₀C)⁻¹N or even combinations of these. The following are approximated
M=bₘUᵣ^{T} and N=bₙWᵣ^{T} (6)
where bₘ and bₙ are obtained using the Moore-Penrose pseudoinverse.
bₘ=MUᵣ(Uᵣ^{T}Uᵣ)⁻¹ and bₙ=NWᵣ(Wᵣ^{T}Wᵣ)⁻¹ (7)
The circuit transfer function now becomes

$$H ( s ) \approx {U}_{r} {\underbrace{{b}_{m}^{T} {( G + sC )}^{- 1} {b}_{n}}}_{{H}_{r} ( s )} {W}_{r}^{T} \qquad ( 8 )$$

Conventional model order reduction techniques can now be applied to
Hᵣ(s)=bₘ^{T}(G+sC)⁻¹bₙ (9)
which is just a r×r matrix transfer function, and obtain \tilde{H}ᵣ(s). The complete transfer function is approximated by
H(s)≈Uᵣ\tilde{H}ᵣ(s)Wᵣ^{T} (10)
where all the matrices involved have O(r²) non-zero entries.

By complete matrix-transfer function we mean a transfer function that completely characterizes a circuit block. It can be, for example, the full Z-parameter matrix relating all the port currents to all port voltages, or the S-parameter matrix, or any other representation.

The foregoing comprised a discussion of the compression algorithm. With respect to the recursive algorithm of the present invention, it is assumed that the input ports are sorted, to the extent that it is possible, according to an electric distance metric. In other words, ports with indices that are close to each other are likely to be electrically close, and widely separated indices are likely to correspond to electrically distant ports. This indexing policy does not have to be absolutely enforced but it can significantly affect the effectiveness of the model reduction.

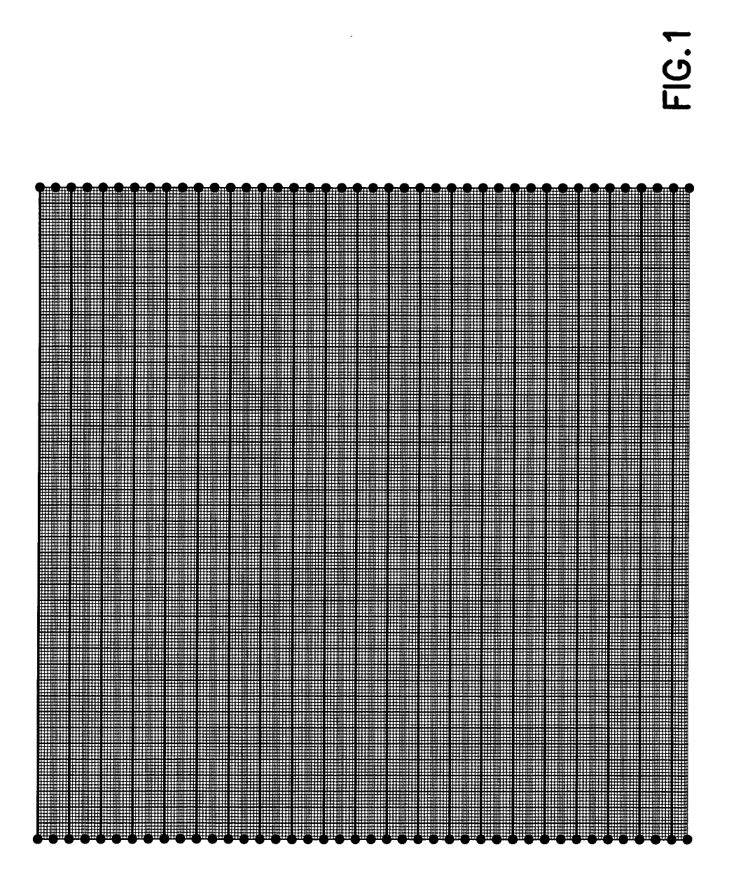

For example, consider the rectangular grid network in FIG. 1, modeling a portion of the power grid, that has ports on the right and on the left edges. The Laplace transform of the state equations of this system are
(G+sC)X=BI
V=B^{T}X (11)
where G and C are matrices that describe the resistive and the reactive elements comprising the mesh and B is the vector that defines the I/O ports to the subcircuit. The equations determine the following transfer function that establishes the relationship between port currents and port voltages
H(s)=B^{T}(G+sC)⁻¹B
The vector B which defines the ports is partitioned in two components: B=[Bₗ Bᵣ], with Bₗ and Bᵣ selecting the ports on the left and right sides of the grid, respectively. The partitioning of the ports results in the partitioning of the transfer function as follows:

$$\begin{matrix}H ( s ) = {{B}^{T} ( G + sC )}^{- 1} B \\ = [ \begin{matrix}{{B}_{l}^{T} ( G + sC )}^{- 1} {B}_{l} & {{B}_{l}^{T} ( G + sC )}^{- 1} {B}_{r} \\ {{B}_{r}^{T} ( G + sC )}^{- 1} {B}_{l} & {{B}_{r}^{T} ( G + sC )}^{- 1} {B}_{r}\end{matrix} ]\end{matrix} \qquad ( 12 )$$

It is assumed that model order reduction is performed separately on the four components of the transfer function matrix resulting in the following reduced matrix

$$\tilde{H} ( s ) = [ \begin{matrix}{b}_{l}^{T} {\tilde{Y}}_{ll}^{- 1} {b}_{l} & {d}_{l}^{T} {\tilde{Y}}_{lr}^{- 1} {d}_{r} \\ {d}_{r}^{T} {\tilde{Y}}_{lr}^{- 1} {d}_{l} & {b}_{r}^{T} {\tilde{Y}}_{rr}^{- 1} {b}_{r}\end{matrix} ] \qquad ( 13 )$$

where for notational brevity we denote \tilde{Y}_{pq}=\tilde{G}_{pq}+s\tilde{C}_{pq}. Note also that the off-diagonal blocks are just transposes of each other.

This transfer function approximates the port current to port voltage relationship

$$[ \begin{matrix}{V}_{l} \\ {V}_{r}\end{matrix} ] = [ \begin{matrix}{b}_{l}^{T} {\tilde{Y}}_{ll}^{- 1} {b}_{l} & {d}_{l}^{T} {\tilde{Y}}_{lr}^{- 1} {d}_{r} \\ {d}_{r}^{T} {\tilde{Y}}_{lr}^{- 1} {d}_{l} & {b}_{r}^{T} {\tilde{Y}}_{rr}^{- 1} {b}_{r}\end{matrix} ] [ \begin{matrix}{I}_{l} \\ {I}_{r}\end{matrix} ] \qquad ( 14 )$$

where for notational convenience ≈ is replaced with =. This reduced system is rewritten in state variable form using [Xₗₗ, Xᵣₗ, Xₗᵣ, Xᵣᵣ]T as the state of the reduced system
\tilde{Y}ₗₗXₗₗ=bₗIₗ, Vₗₗ=bₗ^{T}Xₗₗ
\tilde{Y}ₗᵣXₗᵣ=dᵣIᵣ, Vₗᵣ=dₗ^{T}Xₗᵣ, Vₗ=Vₗₗ+Vₗᵣ
\tilde{Y}ₗᵣ^{T}Xᵣₗ=dₗIₗ, Vᵣₗ=dᵣ^{T}Xᵣₗ
\tilde{Y}ᵣᵣXᵣᵣ=bᵣIᵣ, Vᵣᵣ=bᵣ^{T}Xᵣᵣ, Vᵣ=Vᵣₗ+Vᵣᵣ
These equations are then gathered in matrix form and arranged in a way that results in a symmetric system

$$[ \begin{matrix}{\tilde{Y}}_{ll} & & & \\ & 0 & {\tilde{Y}}_{lr} & \\ & {\tilde{Y}}_{lr}^{T} & 0 & \\ & & & {\tilde{Y}}_{rr}\end{matrix} ] [ \begin{matrix}{X}_{ll} \\ {X}_{rl} \\ {X}_{lr} \\ {X}_{rr}\end{matrix} ] = [ \begin{matrix}{b}_{l} & \\ & {d}_{r} \\ {d}_{l} & \\ & {b}_{r}\end{matrix} ] [ \begin{matrix}{I}_{l} \\ {I}_{r}\end{matrix} ] \\ [ \begin{matrix}{V}_{l} \\ {V}_{r}\end{matrix} ] = {[ \begin{matrix}{b}_{l} & \\ & {d}_{r} \\ {d}_{l} & \\ & {b}_{r}\end{matrix} ]}^{T} [ \begin{matrix}{X}_{ll} \\ {X}_{rl} \\ {X}_{lr} \\ {X}_{rr}\end{matrix} ]$$

When any of these transfer function sub-matrices can be modeled by low-rank models as shown in the previous section, or its number of ports is sufficiently small, it is approximated by a sparse reduced-order model. Otherwise in the recursive method of the present invention the sub-block is further subdivided and the process continues recursively until all the sub-blocks are modeled by sparse approximations.

Continuing the example and assuming that the off-diagonal transfer function sub-matrix
Hₗᵣ=Bₗ^{T}(G+sC)⁻¹Bᵣ (15)
can be approximated by the low rank reduced order model. It is observed that, G and C, being symmetric matrices, Hₗᵣ=Hₗᵣ^{T}, so is sufficient to work on only one of the blocks. Applying the compression method Bₗ and Bᵣ are approximated by
Bₗ≈bₗUₗ^{T} and Bᵣ≈bᵣWᵣ^{t} (16)

Standard model reduction is than applied to the inner part of the expression resulting in a sparse multi-port model

$$\begin{matrix}{H}_{lr} \approx {U}_{l} \underbrace{{b}_{l}^{T} {( G + sC )}^{- 1} {b}_{r}}_{MOR} {W}_{r}^{T} \\ \approx {U}_{l} {u}_{l}^{T} {\tilde{Y}}_{lr}^{- 1} {u}_{r} {W}_{r}^{T}\end{matrix} \qquad ( 17 )$$

In other words the current to voltage transfer function Vₗᵣ=HₗᵣIₗᵣ can be approximated in terms of fewer state variables since
Vₗᵣ=Uₗuₗ^{T}\tilde{Y}ₗᵣ⁻¹uᵣWᵣ^{T}Iₗᵣ (18)
can be expressed as
\tilde{Y}ₗᵣXₗᵣ=uᵣWᵣ^{T}Iₗᵣ (19)
Vₗᵣ=Uₗuₗ^{T}Xₗᵣ (20)
The expression in the hierarchical decomposition is replaced accordingly:

$$[ \begin{matrix}{\tilde{Y}}_{ll} & & & \\ & 0 & {\tilde{Y}}_{lr} & \\ & {\tilde{Y}}_{lr}^{T} & 0 & \\ & & & {\tilde{Y}}_{rr}\end{matrix} ] [ \begin{matrix}{X}_{ll} \\ {X}_{rl} \\ {X}_{lr} \\ {X}_{rr}\end{matrix} ] = [ \begin{matrix}{b}_{l} & \\ & {u}_{r} {W}_{r}^{T} \\ {u}_{l} {U}_{l}^{T} & \\ & {b}_{r}\end{matrix} ] [ \begin{matrix}{I}_{l} \\ {I}_{r}\end{matrix} ] \\ [ \begin{matrix}{V}_{l} \\ {V}_{r}\end{matrix} ] = [ \begin{matrix}{b}_{l} & \\ & {u}_{r} {W}_{r}^{T} \\ {u}_{l} {U}_{l}^{T} & \\ & {b}_{r}\end{matrix} ] [ \begin{matrix}{X}_{ll} \\ {X}_{rl} \\ {X}_{lr} \\ {X}_{rr}\end{matrix} ]$$

The resulting submatrices that correspond to off-diagonal terms are small and sparse when the correlation assumptions hold well. The diagonal terms Yₗₗ and Yᵣᵣ had their port count reduced by half. Furthermore, in the recursive method of the present invention, this compression of sub-block models can be repeated recursively on the diagonal terms until the off-diagonal elements no longer yield significant reductions through correlation exploitation.

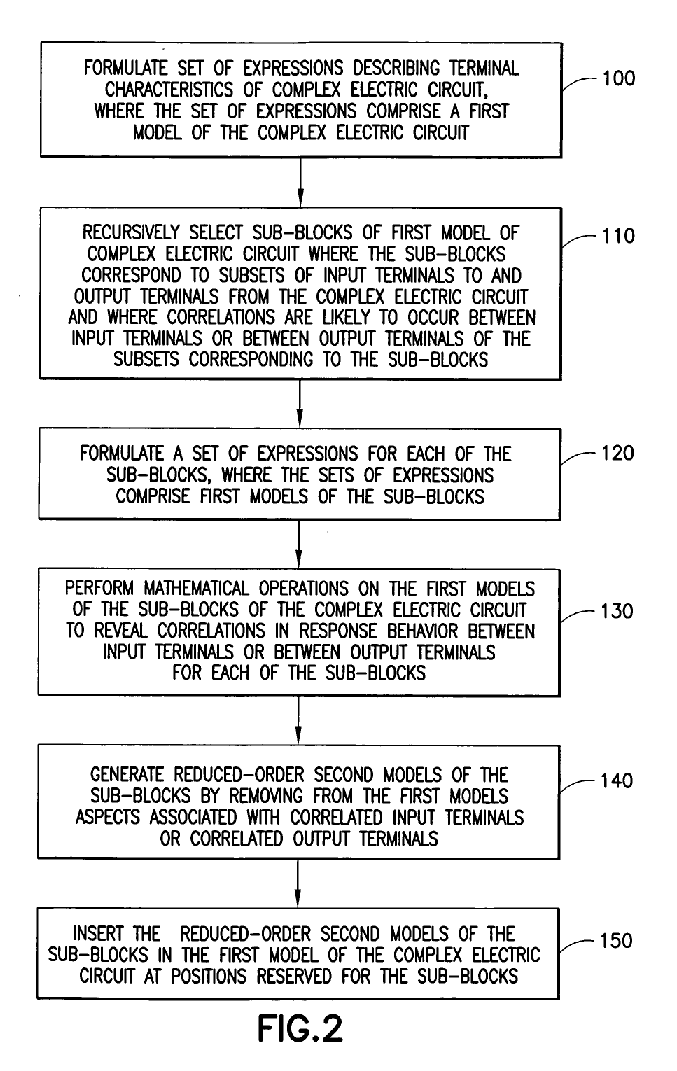

An example of the foregoing recursive method in accordance with an alternate embodiment of the present invention is depicted in FIG. 2. In the first step at 100, a set of expressions describing the terminal characteristics of a complex electric circuit are formulated, where the set of expressions comprise a first model of the complex electric circuit. Next, beginning at step 110, sub-blocks of the first model of the complex electric circuit are recursively selected, where the sub-blocks correspond to subsets of input terminals to and output terminals from the complex electric circuit and wherein the subsets selected are likely to have correlations between input terminals or correlations between output terminals. Then at step 120, a set of expressions are formulated for each of the sub-blocks corresponding to the subsets, where the set of expressions comprise first models of the sub-blocks. Then, at step 130, mathematical operations are performed on the first models of the sub-blocks of the complex electric circuit to reveal correlations in response behavior between input terminals or between output terminals for each of the sub-blocks. Next, at step 140, reduced-order second models of the sub-blocks are generated by removing from the first models of the sub-blocks aspects associated with correlated input terminals or correlated output terminals. Then, at step 150, the reduced-order second models of the sub-blocks are inserted in the first model of the complex electric circuit in respective positions reserved for each of the sub-blocks.

In a variant of the method depicted in FIG. 2, performing mathematical operations on the first models the sub-blocks (step 130) would comprise performing singular value decomposition on the first models of the sub-blocks. In another variant of the method of FIG. 2, reduced-order second models of the sub-blocks of the complex electric circuit would be generated (step 140) by discarding null singular values of the singular value decompositions of the first models of the sub-blocks, and generating the reduced-order second models of the sub-blocks from the retained non-zero singular values.

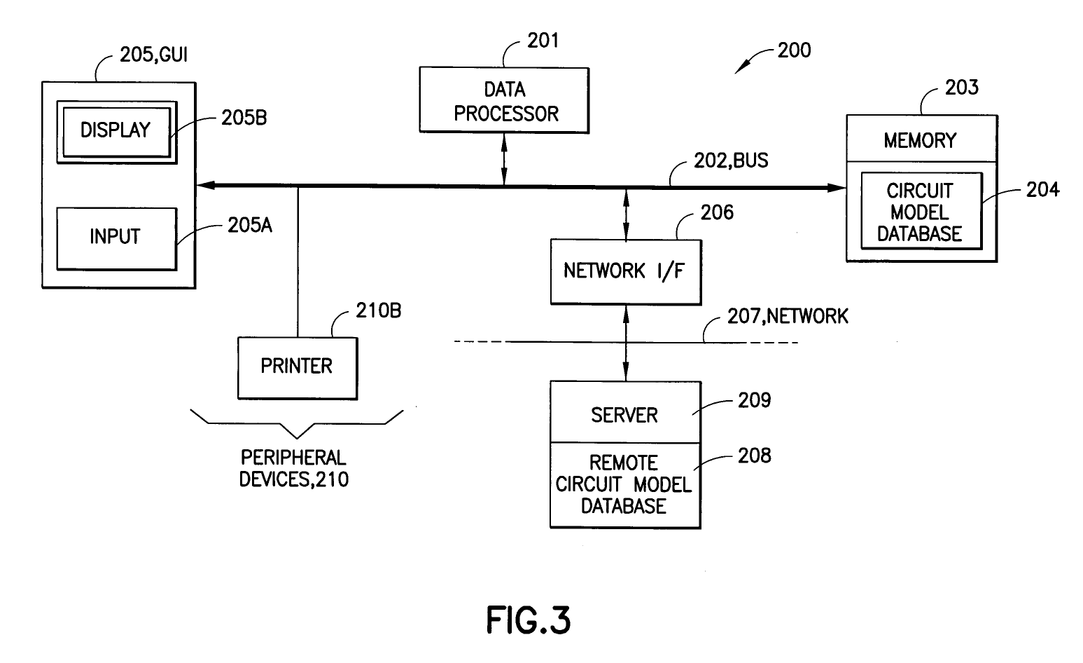

A computer system for practicing the methods of the present invention is depicted in simplified form in FIG. 3. The data processing system 200 includes at least one data processor 201 coupled to a bus 202 through which the data processor 201 may address a memory sub-system 203, also referred to herein simply as the memory 203. The memory 203 may include RAM, ROM and fixed and removable disks and/or tape. The memory 203 is assumed to store at least one program comprising instructions for causing the data processor 201 to execute methods in accordance with the teachings of the invention. Also stored in the memory 203 can be at least one database 204 containing information describing the characteristics of a complex electric circuit to be modeled in accordance with the teachings of the present invention. The data processor 201 is also coupled through the bus 202 to a user interface, preferably a graphical user interface (“GUI”) 205 that includes a user input device 205A, such as one or more of a keyboard, a mouse, a trackball, a voice recognition interface, as well as a user display device 205B, such as a high resolution graphical CRT display terminal, a LCD display terminal, or any suitable display device. With these input/output devices, a user can perform the steps of the methods of the present invention where user-specified values are required.

The data processor 201 may also be coupled through the bus 202 to a network interface 306 that provides bidirectional access to a data communications network 207, such as an intranet and/or the internet. In various embodiments of the present invention, a model of a complex electric circuit can be uploaded though the internet for model order reduction performed by one or more programs stored on a remote website. Alternatively, one or more programs capable of performing model order reduction in accordance with the preferred embodiments of the present invention can be downloaded from a remote site to a user's computer.

In general, these teachings may be implemented using at least one software program running on a personal computer, a server, a microcomputer, a mainframe computer, a portable computer, an embedded computer, or by any suitable type of programmable data processor 201. The use of the model order reduction methods of the present invention substantially improves the analysis and simulation of complex electric circuits and linear systems. The methods may be used to perform model order reduction on models of complex electric circuits stored in or referenced by the database 204, or in the remotely stored database 208 over the network 207 and in cooperation with the server 209.

As an example of the method and apparatus of the present invention, model order reduction is applied to an RC rectangular mesh that would result from the modeling of the on-chip power-grid depicted in FIG. 1. Since the grid is quite regular, it is expected that the responses of the signals will be highly correlated. In the instant example, all of the input/output ports are on the left and right side of the mesh. Assuming the mesh is of size 50×60 the transfer function that the reduced-order model needs to capture will be a 120×120 matrix-valued rational function. The original network has over 3000 nodes. The compression algorithm is guided by the correlations revealed by
M₀=L^{T}G⁻¹R
M₁=L^{T}(G+s₀C)⁻¹R (21)
The DC component, and a shifted moment around the normalized frequency s₀=0.1.

The methods and apparatus of the present invention can also be used to perform model order reduction on models of complex electric circuits or linear systems representing other moments of the complex electric circuits or linear systems. For example, models representing two or more moments, or frequency-shifted moments can be reduced with the methods and apparatus of the present invention.

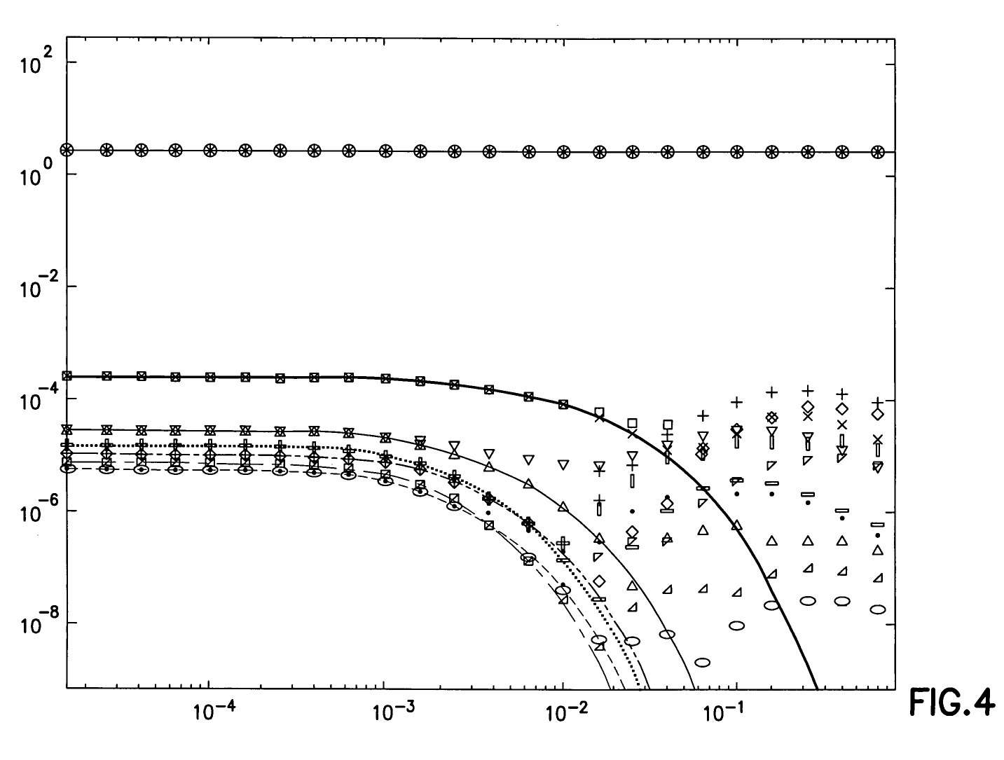

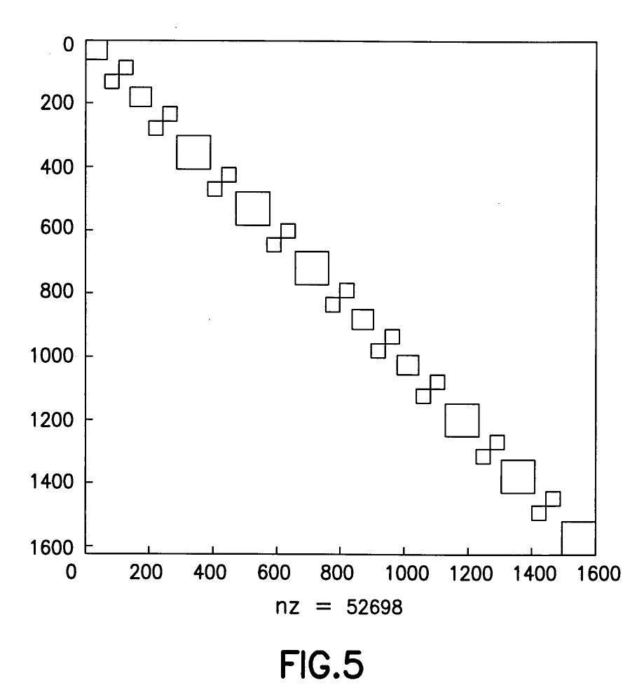

FIG. 4 shows 7 transfer functions out of the 120 matrix generated through the application of the recursive algorithm of the present invention on the mesh. It is observed that the accuracy of the iterative method of the present invention is below that of the brute force application of a standard MOR procedure; however it is above the pre-imposed error limit of 10⁻³. The brute force application of MOR would have produced as part of the “reduced” model a dense matrix of sizes several times 120 the number of I/O ports. Such a matrix is much more expensive to employ in a circuit simulation (if at all possible) than the original 3000×3000 circuit matrices. The recursive method of the present invention produces instead a much sparser, block-structured matrix shown in FIG. 5. It is larger than the matrix that would have been produced by the brute force model reduction but significantly sparser and therefore compatible with efficient use in circuit simulators. Moreover one can take advantage of its block diagonal structure to extract additional efficiency.

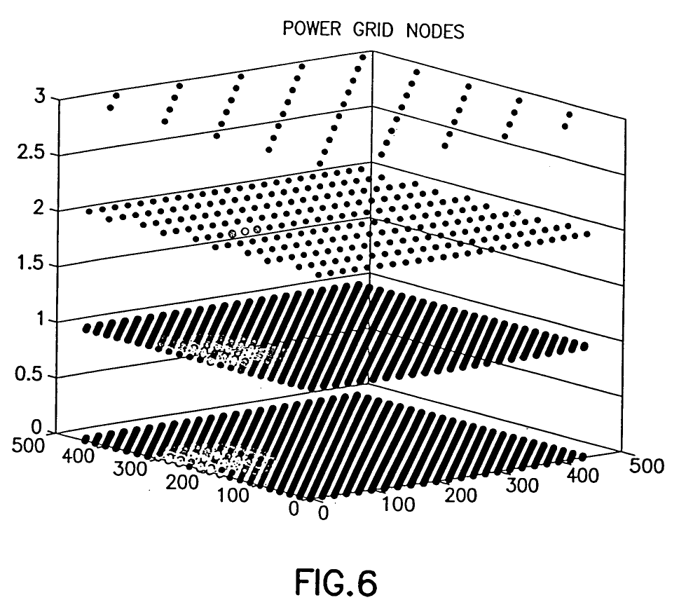

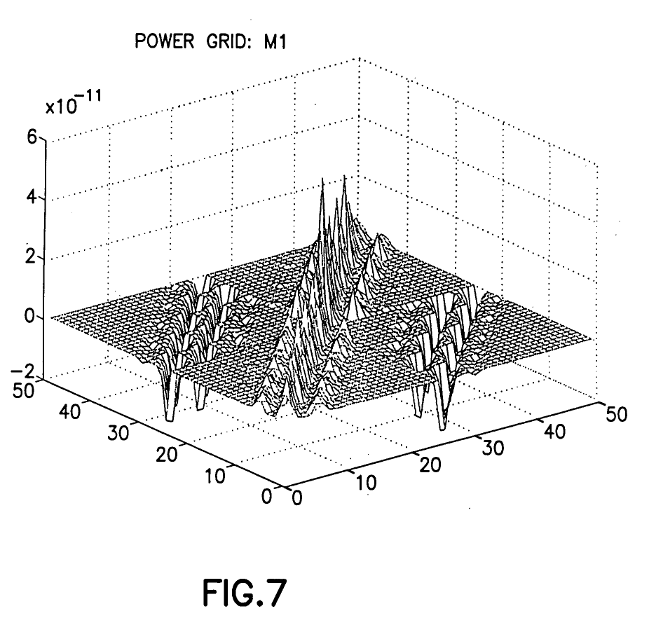

The next example is a realistic power grid section implemented on three layers of metal. The topology of the grid together with current response to a unit excitation applied to one of the nodes in the top layer are shown in FIG. 6. The grid consists of interlaced power and ground wires modeled with just under 3000 nodes. The ports are assumed to be all the nodes of the top layer, 50 in number. Note that the voltage-to-current response is very localized in the X and Y coordinates. FIG. 7 shows the first moment response of the network.

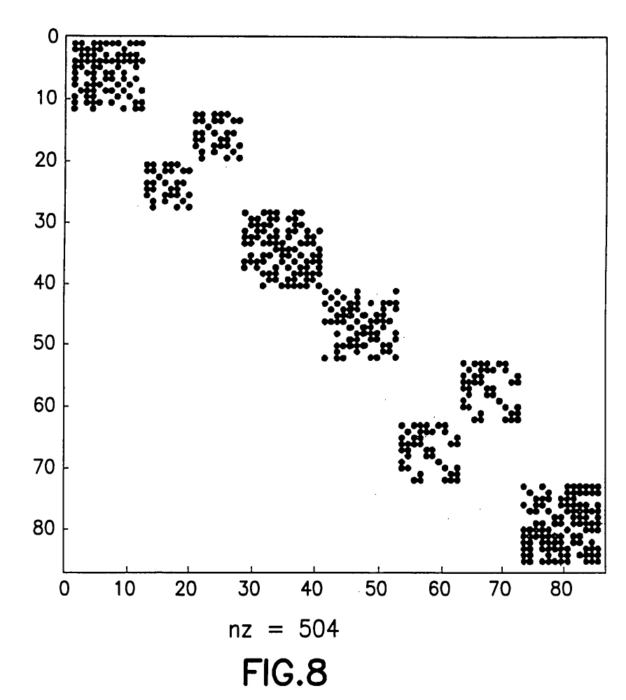

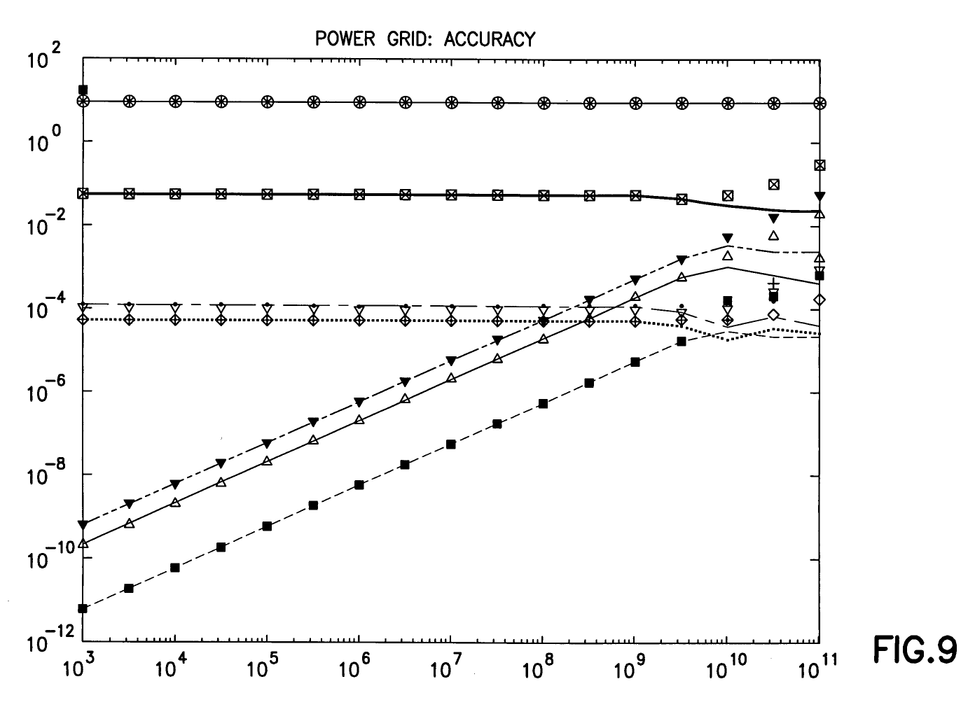

The recursive method of the present invention is applied to the circuit and the structure of the sparsified model is shown in FIG. 8. The recursive method of the present invention achieves a very significant reduction in model complexity at a small accuracy cost. This is shown in FIG. 9.

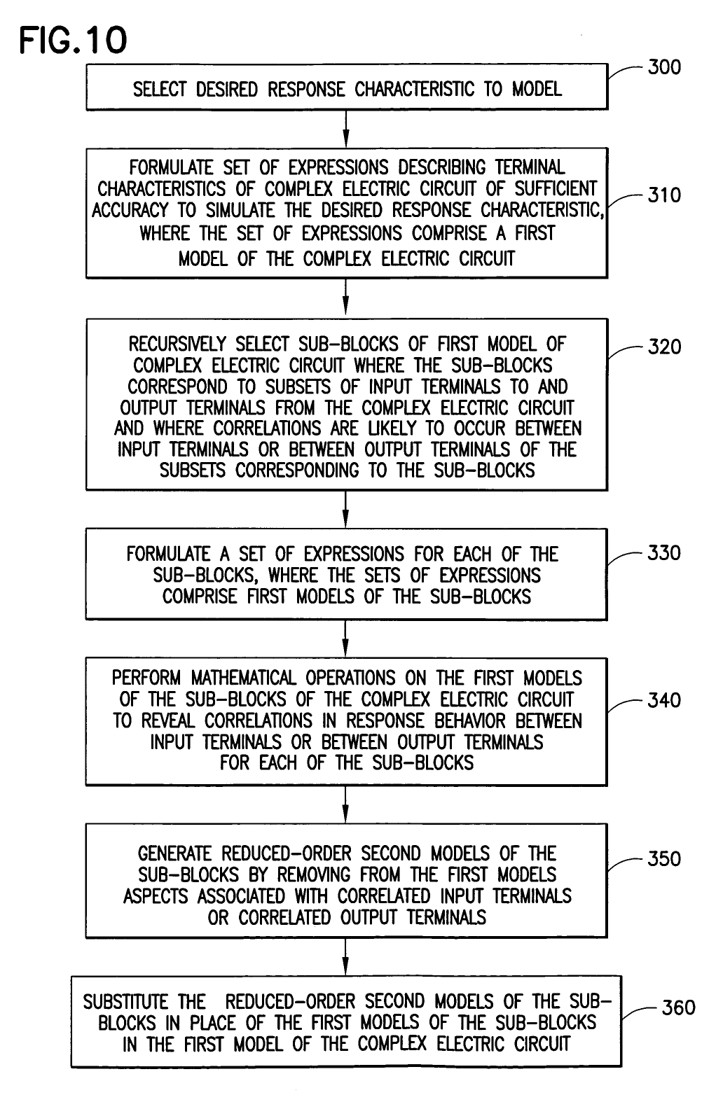

A variant of the present invention operating in accordance with the moment approach to response simulation is depicted in FIG. 10. At step 300, the desired response characteristic (e.g., the DC response) of a complex electric circuit to be modeled is selected. Next, at step 310, expressions of sufficient fidelity to accurately model the selected response characteristic of the complex electric circuit are formulated, wherein the expressions constitute a first model of the complex electric circuit. Then, beginning at step 320, sub-blocks of the first model of the complex electric circuit are recursively selected, where the sub-blocks correspond to subsets of input terminals to and output terminals from the complex electric circuit and wherein the sub-blocks selected are likely to have correlations between input terminals or correlations between output terminals corresponding to the subsets. Next, at step 330, a set of expressions are formulated for each of the sub-blocks, where the set of expressions comprise first models of the sub-blocks. Then, at step 340, mathematical operations are performed on the first models of the sub-blocks of the complex electric circuit to reveal correlations in response behavior between input terminals or between output terminals for each of the sub-blocks. Next, at step 350, reduced-order second models of the sub-blocks are generated by removing from the first models of the sub-blocks aspects associated with correlated input terminals or correlated output terminals. Then, at step 360, the reduced-order second models of the sub-blocks are inserted in the first model of the complex electric circuit at respective positions reserved for each of the sub-blocks.

In a variant of the method depicted in FIG. 10, performing mathematical operations on the first models the sub-blocks (step 340) would comprise performing singular value decomposition on the first models of the sub-blocks. In another variant of the method of FIG. 10, reduced-order second models of the sub-blocks of the complex electric circuit would be generated (step 350) by recalling a desired tolerance level for modeling the complex electric circuit; discarding singular values of the singular value decompositions of the first models of the sub-blocks not needed to achieve the desired tolerance level; and generating reduced-order second models of the sub-blocks from the retained singular values.

The present invention provides a method for model-order reduction of complete linear subcircuits characterized by a very large number of terminals. Previously, such systems were not amenable to reduction, since applying brute force model order reduction methods could result in “reduced” models that are more complex to store and evaluate than the original circuit. This apparent paradox is explained by the fact that reduced-order models for systems with large number of terminals are based on dense matrices while the original circuit equations are written in terms of sparse matrices albeit much larger.

The recursive method of the present invention restores the sparsity of the reduced order model even in the cases where the numbers of terminals is very large. The method employs the compression algorithm which takes advantage of the correlations between circuit responses at various network terminals. The models resulting from these algorithms become more efficient as the correlation between circuit responses is more pronounced.

Thus it is seen that the foregoing description has provided by way of exemplary and non-limiting examples a full and informative description of the best method and apparatus presently contemplated by the inventors for performing model order reduction of complex electric circuits. The methods and apparatus of the present invention are similarly applicable to linear systems. One skilled in the art will appreciate that the various embodiments described herein can be practiced individually; in combination with one or more other embodiments described herein; or in combination with model order reduction methods differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A signal-bearing medium tangibly embodying a program of machine-readable instructions executable by a digital processing apparatus of a computer system to perform operations comprising model order reduction of a complex electric circuit, the operations comprising:
formulating a set of expressions that describe the input and output characteristics of the complex electric circuit, wherein the set of expressions comprises a first model of the complex electric circuit;
selecting a first sub-block of the first model of the complex electric circuit where the first sub-block corresponds to a first subset of input terminals to and output terminals from the complex electric circuit, wherein at least one correlation in response behavior is likely to exist between at least two input terminals comprising the first subset of input and output terminals;
formulating a set of expressions that relate the input terminals and output terminals comprising the first subset, wherein the set of expressions comprises a first model of the first sub-block;
performing mathematical operations on the first model of the first sub-block to identify at least one correlation between at least two input terminals of the first subset of input terminals to and output terminals from the complex electric circuit;
generating a reduced-order second model of the first sub-block by removing from the first model aspects associated with correlated input terminals; and
inserting the reduced-order second model of the first sub-block in the first model of the complex electric circuit at a position reserved for the first sub-block.

2. The signal-bearing medium of claim 1 wherein the operations further comprise:
recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals comprising each of the additional subsets;
formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks;
performing mathematical operations on the first models of the additional sub-blocks to identify at least one correlation between at least two input terminals for each of the additional sub-blocks;
generating reduced-order second models for each of the additional sub-blocks by removing from the first models aspects associated with correlated input terminals; and
successively inserting the reduced-order second models of the additional sub-blocks in the model of the complex electric circuit at respective positions reserved for each of the additional sub-blocks, wherein each successive insertion creates a new overall model of the complex electric circuit.

3. A signal-bearing medium tangibly embodying a program of machine-readable instructions executable by a digital processing apparatus of a computer system to perform operations comprising model order reduction of a complex electric circuit, the operations comprising:
formulating a set of expressions that describe the input and output characteristics of the complex electric circuit, wherein the set of expressions comprises a first model of the complex electric circuit;
selecting a first sub-block of the first model of the complex electric circuit where the first sub-block corresponds to a first subset of input terminals to and output terminals from the complex electric circuit, wherein at least one correlation in response behavior is likely to exist between at least two output terminals comprising the first subset of input and output terminals;
formulating a set of expressions that relate the input terminals and output terminals comprising the first subset, wherein the set of expressions comprises a first model of the first sub-block;
performing mathematical operations on the first model of the first sub-block to identify at least one correlation between at least two output terminals of the first subset of input terminals to and output terminals from the complex electric circuit;
generating a reduced-order second model of the first sub-block by removing from the first model aspects associated with correlated output terminals; and
inserting the reduced-order second model of the first sub-block in the first model of the complex electric circuit at a position reserved for the first sub-block.

4. The signal-bearing medium of claim 3 wherein the operations further comprise:
recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two output terminals comprising each of the additional subsets;
formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks;
performing mathematical operations on the first models of the additional sub-blocks to identify at least one correlation between at least two output terminals for each of the additional sub-blocks;
generating reduced-order second models for each of the additional sub-blocks by removing from the first models aspects associated with correlated output terminals; and
successively inserting the reduced-order second models of the additional sub-blocks in the model of the complex electric circuit at respective positions reserved for each of the additional sub-blocks, wherein each successive insertion creates a new overall model of the complex electric circuit.

5. A signal-bearing medium tangibly embodying a program of machine-readable instructions executable by a digital processing apparatus of a computer system to perform operations comprising model order reduction of a complex electric circuit, the operations comprising:
formulating a set of expressions that describe the input and output characteristics of the complex electric circuit, wherein the set of expressions comprises a first model of the complex electric circuit;
selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals;
formulating a set of expressions that relate the input terminals and output terminals comprising the first subset, wherein the set of expressions comprises a first model of the first sub-block;
performing mathematical operations on the first model of the first sub-block to identify at least one correlation between at least two input terminals or between at least two output terminals of the first subset of input terminals to and output terminals from the complex electric circuit;
generating a reduced-order second model of the first sub-block by removing from the first model aspects associated with correlated input terminals or correlated output terminals; and
inserting the reduced-order second model of the first sub-block in the first model of the complex electric circuit at a position reserved for the first sub-block.

6. The signal-bearing medium of claim 5 wherein performing mathematical operations on the first model of the first sub-block further comprises:
performing singular value decomposition on the first model of the first sub-block.

7. The signal-bearing medium of claim 6 wherein generating a reduced-order second model of the first sub-block further comprises:
selecting a suitable tolerance for modeling the first sub-block;
eliminating from the singular value decomposition of the first model of the first sub-block singular values not needed to achieve the desired modeling tolerance; and
creating a second reduced-order model of the first sub-block from the retained singular values.

8. The signal-bearing medium of claim 5 wherein the operations further comprise:
selecting a second sub-block from a second model of the complex electric circuit created when the second reduced-order model of the first sub-block is substituted in the first model of the complex electric circuit, wherein the second sub-block corresponds to a second subset of input terminals to and output terminals from the complex electric circuit, wherein at least one correlation in response behavior is likely to exist between at least two input terminals or between at least two output terminals comprising the second subset of input and output terminals;
formulating a set of expressions that relate the input terminals and output terminals comprising the second subset, wherein the set of expressions comprises a first model of the second sub-block;
performing mathematical operations on the first model of the second sub-block to identify at least one correlation between at least two input terminals or between at least two output terminals of the second subset of input terminals to and output terminals from the complex electric circuit;
generating a reduced-order second model of the second sub-block by removing from the first model aspects associated with correlated input terminals or correlated output terminals; and
inserting the reduced-order second model of the second sub-block in the second model of the complex electric circuit at a position reserved for the second sub-block.

9. The signal-bearing medium of claim 5 wherein the operations further comprise:
recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets;
formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks;
performing mathematical operations on the first models of the additional sub-blocks to identify at least one correlation between at least two input terminals or between at least two output terminals of the additional sub-blocks;
generating reduced-order second models for each of the additional sub-blocks by removing from the first models aspects associated with correlated input terminals or correlated output terminals; and
successively inserting the reduced-order second models of the additional sub-blocks in the model of the complex electric circuit at respective positions reserved for each of the additional sub-blocks, wherein each successive insertion creates a new overall model of the complex electric circuit.

10. The signal-bearing medium of claim 9, wherein performing mathematical operations on the first models of the additional sub-blocks further comprises:
performing linear algebraic manipulations on the first models of the additional sub-blocks to identify at least one correlation between at least two input terminals or between at least two output terminals for each of the additional sub-blocks.

11. The signal-bearing medium of claim 10 wherein performing linear algebraic manipulations further comprises:
performing singular value decomposition on each of the first models of the additional sub-blocks.

12. The signal-bearing medium of claim 11 wherein generating reduced-order second models of the additional sub-blocks further comprises:
eliminating from the singular value decompositions of the first models of the additional sub-blocks null singular values associated with correlated input terminals or correlated output terminals; and
creating reduced-order second models of the additional sub-blocks from the non-zero singular values of the singular value decomposition of the first models of the additional sub-blocks.

13. The signal-bearing medium of claim 11 wherein generating reduced-order second models of the additional sub-blocks further comprises:
selecting a suitable tolerance for modeling the additional sub-blocks;
eliminating from the singular value decompositions of the first models of the additional sub-blocks singular values not needed to achieve the desired modeling tolerance; and
creating reduced-order second models of the additional sub-blocks from the retained singular values.

14. A signal-bearing medium tangibly embodying a program of machine-readable instructions executable by a digital processing apparatus of a computer system to perform operations comprising model order reduction of a complex electric circuit, the operations comprising:
selecting which response characteristic of the complex electric circuit to model;
formulating a set of expressions of sufficient accuracy to simulate the selected response characteristic at the input and output terminals of the complex electric circuit, wherein the set of expressions comprises a first model of the complex electric circuit;
selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals;
formulating a set of expressions that relate the input terminals and output terminals comprising the first subset, wherein the set of expressions comprises a first model of the first sub-block;
performing mathematical operations on the first model of the sub-block to identify at least one correlation between at least two input terminals or between at least two output terminals of the first subset of input terminals to and output terminals from the complex electric circuit;
generating a reduced-order second model of the first sub-block by removing from the first model aspects associated with correlated input terminals or correlated output terminals; and
inserting the reduced-order second model of the first sub-block in the first model of the complex electric circuit at a position reserved for the first sub-block.

15. The signal-bearing medium of claim 14 wherein the operations further comprise:
recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets;
formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks;
performing mathematical operations on the first models of the additional sub-blocks to identify at least one correlation between at least two input terminals or between at least two output terminals of the additional sub-blocks;
generating reduced-order second models for each of the additional sub-blocks by removing from the first models aspects associated with correlated input terminals or correlated output terminals; and
successively inserting the reduced-order second models of the additional sub-blocks in the model of the complex electric circuit at respective positions reserved for each of the additional sub-blocks, wherein each successive insertion creates a new overall model of the complex electric circuit.

16. The signal-bearing medium of claim 15 wherein performing mathematical operations on the first models of the additional sub-blocks further comprises:
performing singular value decomposition on each of the first models of the additional sub-blocks.

17. The signal-bearing medium of claim 16 wherein generating reduced-order second models of the additional sub-blocks further comprises:
selecting a suitable tolerance for modeling the additional sub-blocks;
eliminating from the singular value decompositions of the first models of the additional sub-blocks singular values not needed to achieve the desired modeling tolerance; and
creating reduced-order second models of the additional sub-blocks from the retained singular values.

18. A computer system for performing model order reduction on a model of a complex electric circuit, the computer system comprising:
at least one memory to store at least (1) a description of the complex electric circuit and (2) at least one program of machine-readable instructions comprising operations which perform model order reduction on models of complex electric circuits when the at least one program is executed;
at least one processor coupled to the at least one memory, wherein the at least one processor performs at least the following operations when the at least one program is executed:
formulating a set of expressions from the description of the complex electric circuit that describe the input and output characteristics of the complex electric circuit, wherein the set of expressions comprises a first model of the complex electric circuit;
selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals;
formulating a set of expressions that relate the input terminals and output terminals comprising the first subset, wherein the set of expressions comprises a first model of the first sub-block;
performing mathematical operations on the first model of the sub-block to identify at least one correlation between at least two input terminals or between at least two output terminals of the first subset of input terminals to and output terminals from the complex electric circuit;
generating a reduced-order second model of the first sub-block by removing from the first model aspects associated with correlated input terminals or correlated output terminals; and
inserting the reduced-order second model of the first sub-block in the first model of the complex electric circuit at a position reserved for the first sub-block.

19. The computer system for performing model order reduction of claim 18 where performing mathematical operations on the first model of the first sub-block further comprises:
performing linear algebraic manipulations on the first model of the first sub-block to reveal at least one correlation between at least two input terminals or between at least two output terminals.

20. The computer system for performing model order reduction of claim 19 where performing linear algebraic manipulations further comprises:
performing singular value decomposition on the first model of the first sub-block.

21. The computer system for performing model order reduction of claim 20 where generating a reduced-order second model of the first sub-block further comprises:
eliminating from the singular value decomposition of the first model of the first sub-block null singular values associated with correlated input terminals or correlated output terminals; and
creating a second reduced-order model of the first sub-block from the non-zero singular values of the singular value decomposition of the first model.

22. The computer system for performing model order reduction of claim 20 where generating a reduced-order second model of the first sub-block further comprises:
recalling a user-specified tolerance for modeling the complex electric circuit;
eliminating from the singular value decomposition of the first model of the first sub-block singular values not needed to achieve the desired modeling tolerance;
creating a second reduced-order model of the first sub-block from the retained singular values.

23. The computer system for performing model order reduction of claim 18 where the operations further comprise:
recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets;
formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks;
performing mathematical operations on the first models of the additional sub-blocks to identify at least one correlation between at least two input terminals or between at least two output terminals of the additional sub-blocks;
generating reduced-order second models for each of the additional sub-blocks by removing from the first models aspects associated with correlated input terminals or correlated output terminals; and
successively inserting the reduced-order second models of the additional sub-blocks in the model of the complex electric circuit at respective positions reserved for each of the the additional sub-blocks, wherein each successive insertion creates a new overall model of the complex electric circuit.

24. The computer system for performing model order reduction of claim 23 where performing mathematical operations on the first models of the additional sub-blocks further comprises:
performing linear algebraic manipulations on the first models of the additional sub-blocks to identify at least one correlation between at least two input terminals or between at least two output terminals for each of the additional sub-blocks.

25. The computer system for performing model order reduction of claim 24 where performing linear algebraic manipulations further comprises:
performing singular value decomposition on each of the first models of the additional sub-blocks.

26. The computer system for performing model order reduction of claim 25 where generating reduced-order second models of the additional sub-blocks further comprises:
eliminating from the singular value decompositions of the first models of the additional sub-blocks null singular values associated with correlated input terminals or correlated output terminals; and
creating reduced-order second models of the additional sub-blocks from the non-zero singular values of the singular value decomposition of the first models of the additional sub-blocks.

27. The computer system for performing model order reduction of claim 25 where generating reduced-order second models of the additional sub-blocks further comprises:
selecting a suitable tolerance for modeling the additional sub-blocks;
eliminating from the singular value decompositions of the first models of the additional sub-blocks singular values not needed to achieve the desired modeling tolerance; and
creating reduced-order second models of the additional sub-blocks from the retained singular values.

28. The computer system for performing model order reduction of claim 18 wherein the at least one memory comprises at least one remote database accessible over the internet, wherein the description of the complex electric circuit is stored in the at least one remote database.

29. The computer system for performing model order reduction of claim 18 wherein the at least one memory comprises at least one remote database accessible over the internet, wherein the at least one program for performing model order reduction is stored in the at least one remote database.

30. A computer system for performing model order reduction on a model of a complex electric circuit, the computer system comprising:
at least one memory to store at least (1) a description of the complex electric circuit and (2) at least one program of machine-readable instructions comprising operations which perform model order reduction on models of complex electric circuits when the at least one program is executed;
at least one processor coupled to the at least one memory, wherein the at least one processor performs at least the following operations when the at least one program is executed:
recalling a user-specified selection corresponding to a desired response characteristic of the complex electric circuit; wherein that desired response characteristic of the complex electric circuit will be modeled by the computer system;
formulating a set of expressions of sufficient accuracy to simulate the selected response characteristic at the input and output terminals of the complex electric circuit, wherein the set of expressions comprises a first model of the electric circuit;
selecting a first sub-block of the first model of the complex electric circuit where the first sub-block corresponds to a first subset of input terminals to and output terminals from the complex electric circuit, wherein at least one correlation in response behavior is likely to exist between at least two input terminals or between at least two output terminals comprising the first subset of input and output terminals;
formulating a set of expressions that relate the input terminals and output terminals comprising the first subset, wherein the set of expressions comprises a first model of the first sub-block;
performing mathematical operations on the first model of the sub-block to identify at least one correlation between at least two output terminals or between at least two output terminals of the first subset of input terminals to and output terminals from the complex electric circuit;
generating a reduced-order second model of the first sub-block by removing from the first model aspects associated with correlated input terminals or correlated output terminals; and
inserting the reduced-order second model of the first sub-block in the first model of the complex electric circuit at a position reserved for the first sub-block.

31. The computer system for performing model order reduction of claim 30 where the operations further comprise:
recursively selecting additional sub-blocks of the model of the complex electric circuit, wherein each of the additional sub-blocks corresponds to an additional subset of input terminals to and output terminals from the complex electric circuit, wherein with respect to each of the additional subsets at least one correlation is likely to exist between at least two input terminals or between at least two output terminals comprising each of the additional subsets;
formulating a set of expressions for each of the additional sub-blocks, wherein each set of expressions relates the input and output terminals of the additional subset corresponding to that sub-block, and where the sets of expressions for each of the additional sub-blocks comprise first models of each of the additional sub-blocks;
performing mathematical operations on the first models of the additional sub-blocks to identify at least one correlation between at least two input terminals or between at least two output terminals of the additional sub-blocks;
generating reduced-order second models for each of the additional sub-blocks by removing from the first models aspects associated with correlated input terminals or correlated output terminals; and
successively inserting the reduced-order second models of the additional sub-blocks in the model of the complex electric circuit at respective positions reserved for each of the additional sub-blocks, wherein each successive insertion creates a new overall model of the complex electric circuit.

32. The computer system for performing model order reduction of claim 31 where performing mathematical operations on the first models of the additional sub-blocks further comprises:
performing singular value decomposition on each of the first models of the additional sub-blocks.

33. The computer system for performing model order reduction of claim 32 where generating reduced-order second models of the additional sub-blocks further comprises:
selecting a suitable tolerance for modeling the additional sub-blocks;
eliminating from the singular value decompositions of the first models of the additional sub-blocks singular values not needed to achieve the desired modeling tolerance; and
creating reduced-order second models of the additional sub-blocks from the retained singular values.

34. The computer system for performing model order reduction of claim 30 where the desired response characteristic corresponds to the DC response of the complex electric circuit.

35. The computer system for performing model order reduction of claim 30 where the desired response characteristic corresponds to the delay response of the complex electric circuit.

36. The computer system for performing model order reduction of claim 30 where the desired response characteristic corresponds to the DC and delay response of the complex electric circuit.

37. The computer system for performing model order reduction of claim 30 where the desired response characteristic corresponds to a frequency-shifted moment of the complex electric circuit.

38. A signal bearing medium tangibly embodying a program of machine-readable instructions executable by a digital processing apparatus of a computer system to perform operations comprising model order reduction of a linear system, the operations comprising:
formulating a set of expressions that describe the input and output characteristics of the linear system, wherein the set of expressions comprises a first model of the linear system;
selecting a first sub-block of the first model of the linear system where the first sub-block corresponds to a first subset of inputs to and outputs from the linear system, wherein at least one correlation in response behavior is likely to exist between at least two inputs or between at least two outputs comprising the first subset of inputs and outputs;
formulating a set of expressions that describe the input and output characteristics of the first sub-block, wherein the set of expressions comprises a first model of the first sub-block;
performing mathematical operations on the first model of the first sub-block to identify at least one correlation between at least two inputs or between at least two outputs of the sub-block;
generating a reduced-order second model of the sub-block by removing from the first model of the first sub-block aspects associated with correlated inputs or correlated outputs; and
inserting the reduced-order second model of the first sub-block in the first model of the linear system at a position reserved for the first sub-block.

39. The signal-bearing medium of claim 38 wherein the linear system further comprises an analogue system.

40. The signal-bearing medium of claim 38 wherein the linear system further comprises a discrete system.

41. A method for performing model order reduction on a model of a complex electric circuit, the method comprising:
formulating a set of expressions that describe the input and output characteristics of the complex electric circuit, wherein the set of expressions comprises a first model of the electric circuit;
recursively selecting sub-blocks of the model of the complex electric circuit, wherein each of the sub-blocks corresponds to a subset of input terminals to and output terminals from the complex electric circuit, wherein with respect to each of the subsets at least one correlation is likely to exist between at least two input terminals or between at least two output terminals comprising each of the subsets;
formulating a set of expressions for each of the sub-blocks, wherein each set of expressions relates the input and output terminals of the subset corresponding to that sub-block, and where the sets of expressions for each of the sub-blocks comprise first models of each of the sub-blocks;
performing mathematical operations on the first models of the sub-blocks to identify at least one correlation between at least two input terminals or between at least two output terminals of the sub-blocks;
generating reduced-order second models for each of the sub-blocks by removing from the first models aspects associated with correlated input terminals or correlated output terminals; and
successively inserting the reduced-order second models of the sub-blocks in the model of the complex electric circuit at respective positions reserved for each of the sub-blocks, wherein each successive insertion creates a new overall model of the complex electric circuit.

42. The method of claim 41, wherein performing mathematical operations on the first models of the sub-blocks further comprises:
performing singular value decomposition on each of the first models of the sub-blocks.

43. The method of claim 42, wherein generating reduced-order second models of the sub-blocks further comprises:
selecting a suitable tolerance for modeling the sub-blocks;
eliminating from the singular value decompositions of the first models of the sub-blocks singular values not needed to achieve the desired modeling tolerance; and
creating reduced-order second models of the sub-blocks from the retained singular values.

44. A method for performing model order reduction on a model of a complex electric circuit, the method comprising:
selecting which response characteristic of the complex electric circuit to model;
formulating a set of expressions of sufficient accuracy to simulate the selected response characteristics at the input and output terminals of the complex electric circuit, wherein the set of expressions comprises a first model of the complex electric circuit;
recursively selecting sub-blocks of the model of the complex electric circuit, wherein each of the sub-blocks corresponds to a subset of input terminals to and output terminals from the complex electric circuit, wherein with respect to each of the subsets at least one correlation is likely to exist between at least two input terminals or between at least two output terminals comprising each of the subsets;
formulating a set of expressions for each of the sub-blocks, wherein each set of expressions relates the input and output terminals of the subset corresponding to that sub-block, and where the sets of expressions for each of the sub-blocks comprise first models of each of the sub-blocks;
performing mathematical operations on the first models of the sub-blocks to identify at least one correlation between at least two input terminals or between at least two output terminals of the sub-blocks;
generating reduced-order second models for each of the sub-blocks by removing from the first models aspects associated with correlated input terminals or correlated output terminals; and
successively inserting the reduced-order second models of the sub-blocks in the model of the complex electric circuit at respective positions reserved for each of the sub-blocks, wherein each successive insertion creates a new overall model of the complex electric circuit.

45. The method of claim 44, wherein performing mathematical operations on the first models of the sub-blocks further comprises:
performing singular value decomposition on each of the first models of the sub-blocks.

46. The method of claim 45, wherein generating reduced-order second models of the sub-blocks further comprises:
selecting a suitable tolerance for modeling the sub-blocks;
eliminating from the singular value decompositions of the first models of the sub-blocks singular values not needed to achieve the desired modeling tolerance; and
creating reduced-order second models of the sub-blocks from the retained singular values.
